(19) United States
(12) Patent Application Publication
(10) Pub. No.: US 2003/0012336 A1
(43) Pub. Date: Jan. 16, 2003

(54) X-ray concentrator for therapy

(76) Inventors: Webster C. Cash, Boulder, CO (US); Michael D. Weil, Fort Collins, CO (US); Kevin N. Morris, Denver, CO (US)

Correspondence Address: DORR CARSON SLOAN & BIRNEY, PC, 3010 EAST 6TH AVENUE, DENVER, CO, 80206

(21) Appl. No.: 10/176,877

(22) Filed: Jun. 20, 2002

Related U.S. Application Data
(60) Provisional application No. 60/299,542, filed on Jun. 20, 2001.

(51) Int. Cl. G21K 1/06

(52) U.S. Cl. 378/84

(57) ABSTRACT

X-ray radiation from conventional electron-impact x-ray sources can be focused to very high intensity using a curved array of silicon wafers or other crystals having a spiral shape. This optic is of use for high-speed radiation treatment, radiosurgery, and radiotherapy.

This application is based on, and claims priority to U.S. Provisional Patent Application 60/299,542, entitled “X-Ray Concentrator For Therapy”, filed on Jun. 20, 2001.

### BACKGROUND OF THE INVENTION

1. Field of the Invention

The present invention relates generally to the field of radiosurgery. More specifically, the present invention discloses a method and apparatus for concentrating x-rays.

2. Statement of the Problem

Since early in the twentieth century, it has been recognized that the ionizing properties of x-rays are of therapeutic value, as well as diagnostic import. However, treatment of tumors with x-rays has remained a difficult proposition as the cancerous cells require about the same radiation dose to kill as healthy cells. Thus, techniques for concentrating the dose in the target area with minimum dose to surrounding healthy tissue (beneficial therapeutic ratio) are of basic importance in medical applications of radiation treatments.

In recent years photons with energy in excess of 1 MeV have been preferred over the more traditional x-rays in the 20 to 150 keV band. This is because the beam intensity falls less quickly as it passes through the body, thereby yielding uniform dose. Second, the buildup effect of electrons with megavoltage treatment spares any large dose to the skin. Third, as the beam absorption is dependent on density only (not composition), megavoltage results in little interaction with bones.

To achieve safe lethal doses deep inside the body, the beam is aimed at the target from a variety of directions, spreading the beam across as much healthy tissue as possible, but always remaining pointed at the target. This is accomplished by creating dozens of narrow beams from radioactive decay (as in the case of the gamma knife) or by scanning a source across a series of angles or arcs (in the case of a linear accelerator). Both techniques are proven and in general practice. However, collateral damage to nearby tissue remains a major and limiting problem to successfully destroying pathologic targets. The beams, regardless of their geometry, spread to the side and overshoot the target.

3. Solution to the Problem

Nothing in the prior art shows crystals cut to a predetermined shape in order to focus x-rays for treatment of cancer. In addition, nothing in the prior art shows crystals cut to a predetermined shape and placed in a predetermined array in order to focus x-rays for treatment of cancer.

### SUMMARY OF THE INVENTION

This invention provides an x-ray concentrator that enables x-ray radiation from a conventional electron-impact x-ray source to be focused to very high intensity using an array of curved crystalline or polycrystalline wafers, such as silicon or graphite. This optic is of particular use for high-speed radiation treatment, radiosurgery, and radiotherapy. In the preferred embodiment, the wafers have a generally spiral curvature and are radially aligned about a common central axis. The crystal in one embodiment of the present invention is made of short sections having edges, with the sections spaced on a crystal holder so the x-ray radiation illuminates the edges of the sections.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 shows θ as the angle between the direction of the approach and the surface of the crystal

FIG. 2 shows a simple geometry that supports the concentration of radiation using a silicon crystal cut from a wafer.

FIG. 3 is a schematic representation of the distance from the x-ray source to the surface of a crystal having a spiral curve.

FIG. 4 is an array of single bent crystals aligned about a common, central axis.

FIG. 5 shows diffraction of x-rays from the leading and trailing edges of a crystal.

FIG. 6 shows illumination of the crystalline planes from the side.

FIG. 7 shows a crystal broken into shorter sections.

FIG. 8 illustrates nested rings of crystals.

### DETAILED DESCRIPTION OF THE INVENTION

Ionizing radiation in the band between 20 keV and 150 keV (kilovoltage x-rays) can be used in medical therapy. The radiation, if directed at diseased tissue, can kill that tissue non-surgically. If the radiation is concentrated into a focused beam with optics (devices which redirect the beam by reflection, refraction, or diffraction), and the target is placed at the focus, then the tissue the beam passes through en route to the focus will experience a lower dose of radiation and thereby survive. Building such a lens has proven to be very difficult because the collecting power of all optics (for radiation in this band) to this point has been so low as to render the total flux in the concentrated beam lower than the direct flux from the source.

Most medical x-ray sources operate by directing an electron beam through a high voltage to impact upon a tungsten target. The x-rays diverge from the target into the hemisphere above the tungsten. Most of these travel in directions far away from the target and are wasted in the shielding around the source or in the collimator jaws that restrict the angles at which x-rays are allowed to emerge. This leads to an inefficient use of the radiation generated in the source. For example, a hemisphere has 2π steradians of radiation, while a 1 cm diameter tumor at a distance of 50 cm from the source subtends only 0.0003 steradians, and represents an efficiency of under 0.01%.

The flux from the source can be characterized as F photons/s/ster, so that F is the number of x-rays passing into a steradian each second. The target, having an area A at a distance D then subtends A/D² steradians and will be exposed to FA/D² x-rays per second when illuminated by the source directly.

If a concentrator or optic can be built, its efficiency can be expressed as εS, where ε is the efficiency of the optic in redirecting the light to a focus, and S is the number of steradians of aperture in the concentrator. When placed in front of the source the concentrator will redirect FεS x-rays per second to the target. Thus the ratio of flux delivered is εSD²/A compared to direct illumination. If the value of this ratio is greater than one, then speed of treatment will be enhanced. For the example above, where A/D² is 0.0003, the ratio is 3000εS, so εS can be small and still be useful.

The problem is that it is difficult to redirect x-rays through large angles with good efficiency. Techniques for bending the path of an x-ray include reflection at grazing incidence off of multi-layer mirrors and Bragg reflection off of crystals.

While it is widely known that Bragg reflection operates through large angles, it has generally been overlooked as a solution to the problem because the efficiency is low. However, low efficiency (ε) can be tolerated if the acceptance angle (S) is high enough. For example, if the concentrator accepts two steradians (S=2), then the crystals need efficiency of only 0.16% to create a lens that can treat a 1 cm tumor at 50 cm, which is ten times faster than the direct beam. In essence, the number of x-rays available for redirection to the target rises as the square of the angle through which they are reflected. Since the target tends to be about a degree in extent, if x-rays from many degrees off axis can be gathered, then the efficiency does not need to be high, and Bragg reflection becomes a viable basis for the lens.

The interaction of an x-ray with a crystal is described by either Laue's equations or the Bragg's law. Laue's equations are the crystalline equivalent of the diffraction grating equation and produce diffracted radiation which is non-specular and highly wavelength dependent. Because our sources emit a broad range of wavelengths, the Laue geometry is not attractive. The Bragg law, however, describes specular reflection for all wavelengths. It is the intensity of the diffracted radiation that varies with wavelength, not the direction, making it more suitable for concentration of radiation. The Bragg law is given by:

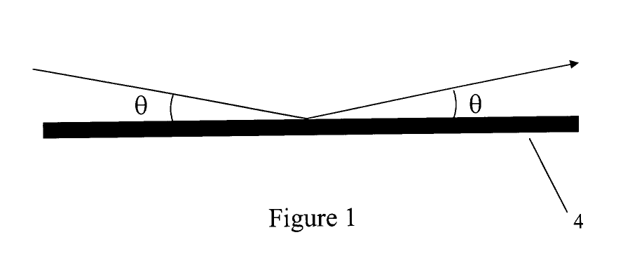

nλ=2d sin θ

where n is the (integral) order number, λ the wavelength of the x-ray, d the lattice spacing, and θ the graze angle. θ is the angle between the direction of the approach and the surface of the crystal 4 as shown in FIG. 1. X-rays that satisfy the law can be reflected back out at the reflection angle (also θ), while those that do not satisfy the constraint are transmitted or absorbed. The x-rays scattered from the layers of the crystals 4 will be in phase if the difference in the distance traveled by the wavefront is an integral number of wavelengths.

The value of d is 3.84 Å for silicon, and the wavelength at which a tungsten target source is brightest is 0.209 Å (59.32 keV), so the angle of first order is 1.56 degrees, which is near the range of grazing incidence. Higher orders, however, reflect at higher angles (well beyond grazing incidence). For example, fifth order reflects at 7.82 degrees, which means that if fifth order and higher can be used, the concentrator can operate over a substantial fraction of a steradian. The fraction of the x-rays that are absorbed is a complex function of x-ray energy, angle, and structure of the crystal. As such, it is not clear, a priori, that the necessary efficiency is available for the desired collimator. However, as θ rises and the order number rises there is a loss of efficiency, so it appears unlikely that θ of 90° (normal incidence) is a realistic geometry. To use the more efficient, lower orders, geometries within an order of magnitude of grazing incidence should be employed.

Any crystal is a candidate for use in the concentrator. Each crystalline composition has different dispersion and efficiency properties, so some are better than others. Similarly, some crystals are commonly available, while others are highly specialized and difficult to obtain. Probably the most convenient to obtain and the lowest cost is the silicon crystal. The wafers of silicon that are made in bulk quantities for the electronics industry are actually silicon crystals with all the accompanying properties including Bragg diffraction. It is inexpensive to purchase a wafer of silicon. They are typically 150 mm in diameter, are about a half a millimeter thick, and come in all of the silicon crystal orientations to the surface. This thickness is enough to generate good diffraction and low enough to allow bending, even though it is brittle.

Other crystals that are used in the invention include, without limitation, graphite. It is to be understood that any crystal having suitable characteristics can be used in the present invention, as will be evident to those skilled in the art.

The large angle through which the x-rays are diffracted provides an advantage in its own right. Because the lens has a large angle of convergence onto the focus it is considered “fast” in the camera sense of the word. A fast lens has a small depth of focus. In this case it means that only tissue near the focus will receive a lethal dose. Small distances before and after the focus will be out of focus and the local dose deposition will be lower.

The key to success is to achieve high radiation dose in unhealthy tissue only. Thus, success in the invention requires that a variety of techniques be brought together to work in concert, including: (a) a source with high output; (b) a source that emits x-rays through a large solid angle; (c) an optic that gathers x-rays from a large solid angle; (d) an optic that concentrates flux on a small target; and (d) an optic with high efficiency.

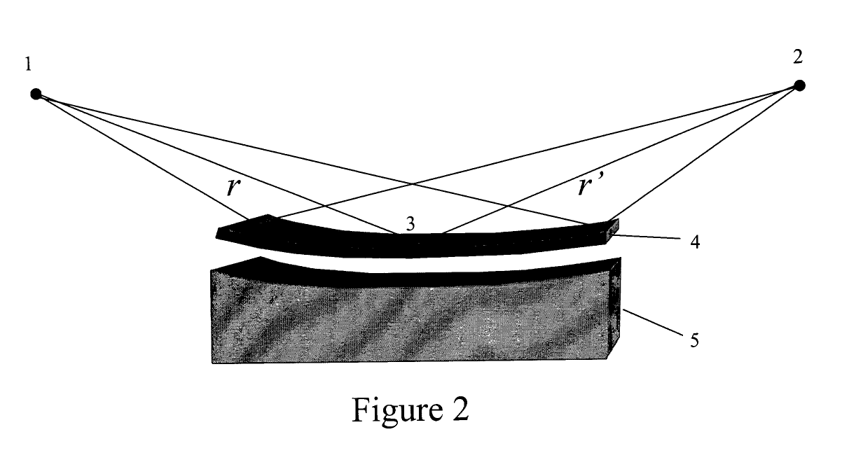

FIG. 2 shows a simple geometry that supports the concentration of radiation using a silicon crystal cut from a wafer. Let us consider a crystal 4 of width w and lengthl. We shall discuss rectangular crystals but note that more complex shapes may improve performance. Although the crystal 4 may be placed at any point between the source 1 and the focal point 2, it is shown at a typical geometry, about half way. We call the distance from 1 to the center 3 of the crystal 4 r. The distance from the center 3 of the crystal 4 to the focal point 2 is called r′. The crystal 4 bends easily to an arc in one dimension but cannot be easily molded in two dimensions. A crystal holder 5 is machined to a constant thickness. One edge of the holder 5 is machined to a pre-determined shape, and the crystal 4 is then bent to conform to the machined shape. There it is bonded in place to hold the shape.

The surface can be curved to approximate the Bragg angle along a portion of its length. In general, the surface shape will be concave to force a focus of the reflected x-rays near the focal point 2. Because the optical surface has been bent in one dimension only, the focus is a line focus. The length of the line is given by the width of the crystal 4 multiplied by the ratio of the distances, i.e. wr′/r.

The shape of the concave arc along the length of the wafer 4 may be chosen for the purpose at hand. In conventional grazing incidence optics a mirror set at the middle and used to refocus from focal point 1 to focal point 2 would be cylindrical with radius of curvature given by:

R=r sin θ=r′ sin θ

which creates a line focus that tends to be quite fine. This works nicely for the concentrator as well. The radius of curvature creates a shape with approximately constant reflection angle along the length.

However, the cylinder is not always the best shape. Consider that we wish to capture a large range of angles to compensate for the low efficiency of the crystal 4. This leads to a large range of incidence angles on the crystal 4. If the source emitted a pure, uniform continuum, then this shape would be as good as any other. However, the source emits very bright tungsten K lines. The brightest line is the W Kα₁ line at 59.3 keV, which can contain as much as 10% of the total output of the source. If this line is tuned to the Bragg angle, then a significant improvement in concentrated flux will result.

It can be shown that the curve that maintains a constant reflection angle with respect to rays diverging from a point is the spiral. It is given by the equation (in polar coordinates):

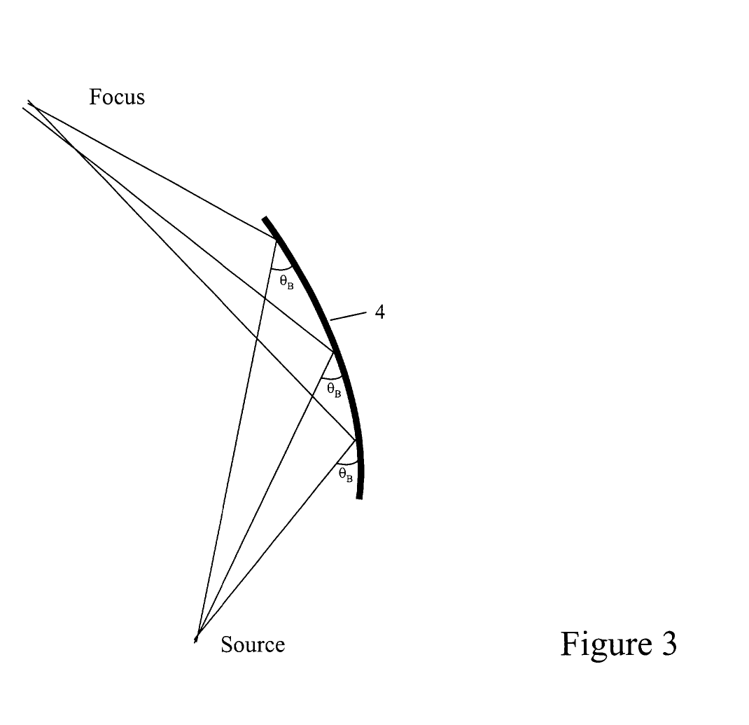

r=r₀e^{(θ/tan θ}^{_{B)}}

where r₀ is the distance from the source to the surface at an angle θ of zero as shown schematically in FIG. 3. θ_{B} is the Bragg angle chosen for the specific wavelength and order. The spiral has the property of optimizing the reflection efficiency along the curve, but does not create a particularly good focus (i.e., a spot of 1 mm or less). Luckily, for medical applications we do not need a particularly high quality focus, and the spiral is adequate for many concentrators.

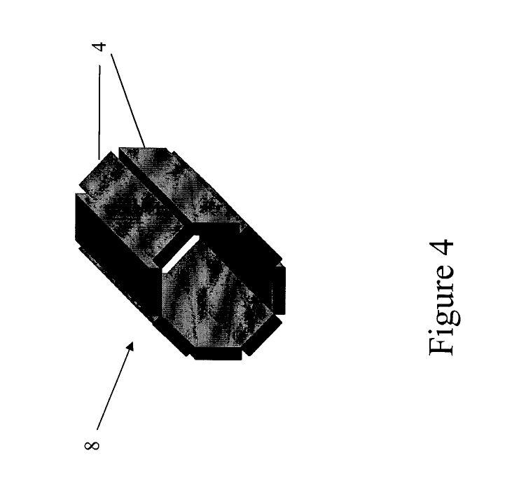

So far, we have described a single, narrow, bent crystal 4. To optimize concentration, it is necessary to make an array 8 of these crystals 4, all aligned about a common, central axis as shown in FIG. 4. This will typically involve dozens of crystals 4, all concentrating at focal point 2 as shown in FIG. 2. The flux f (in photons per second) from such a concentrator is then given by:

f=π(θₘₐₓ²−θₘᵢₙ²)εF

where θₘₐₓ and θₘᵢₙ are the maximum and minimum angles intercepted by the crystal 4.

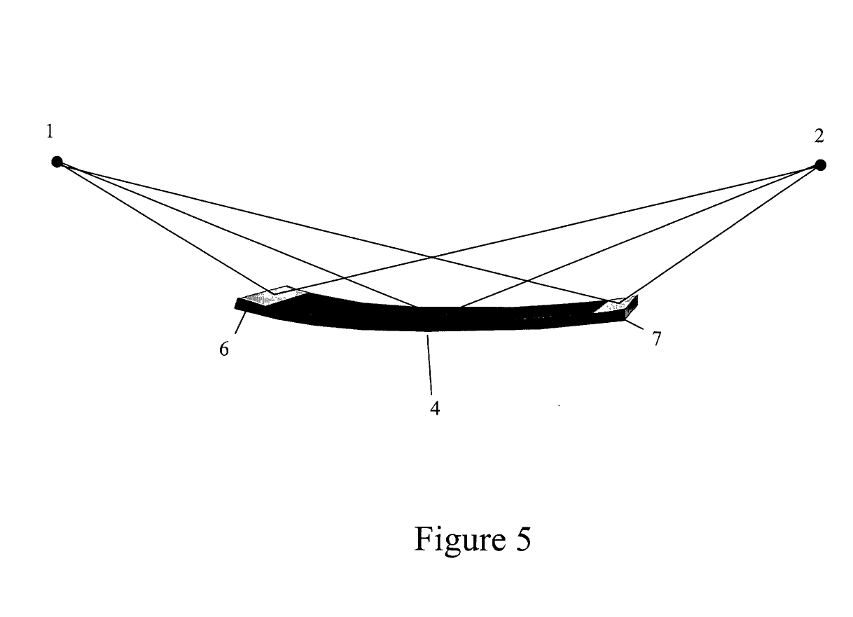

We have discovered that a significant increase in diffraction efficiency occurs in the leading 6 and trailing 7 edges of the crystal 4 as shown in FIG. 5. Well over half of the diffracted x-rays from the crystal 4 can be traced back to the first few 6 and last few 7 millimeters of the lengthl, of the crystal 4. This represents an order of magnitude improvement in diffraction efficiency at the ends, and if applied to the entire crystal 4 yields a large increase in overall efficiency.

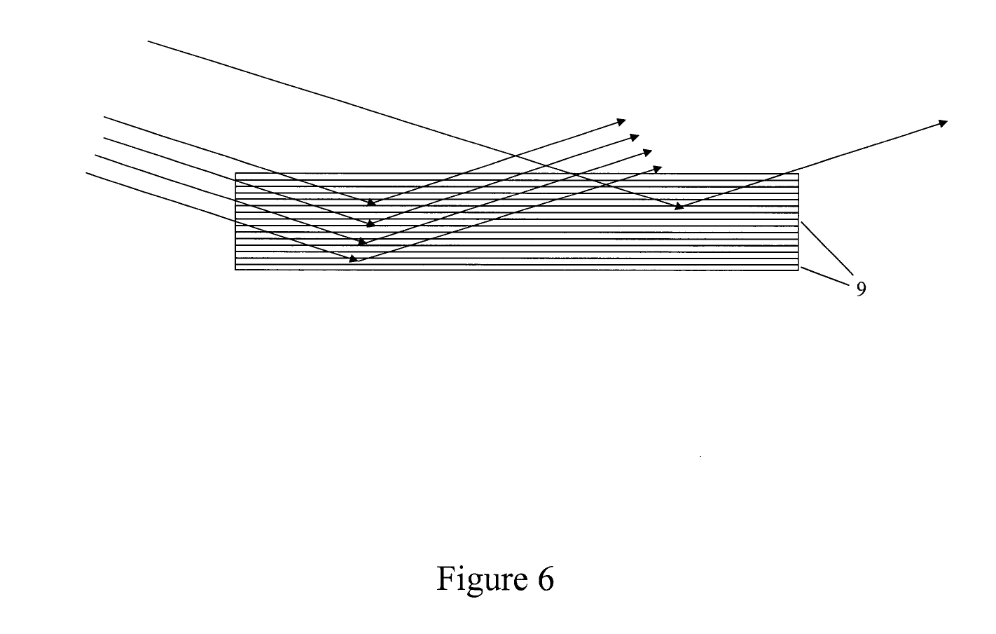

The source of this efficiency enhancement is not known for certain. We believe it may be due to the illumination function of crystalline planes 9 at the end of the crystal 4. Consider FIG. 6, wherein crystalline planes 9 are illuminated from the side. More of the planes 9 deeper inside the crystal 4 are illuminated, where otherwise they are shielded by absorption from above. The efficiency of diffraction is given by the square of the sum of the amplitudes reflected at each plane 9. Thus the diffraction efficiency rises as the square of the depth to which it is illuminated. An increase of a factor of three in illumination depth, as provided by side illumination can thus lead to an order of magnitude increase in diffraction efficiency. Alternatively, the increase may due to the Pendellosung Effect (see Cullity and Stock, Elements of X-ray Diffraction, Prentice Hall, 3^{rd} Edition, 2001, page 181).

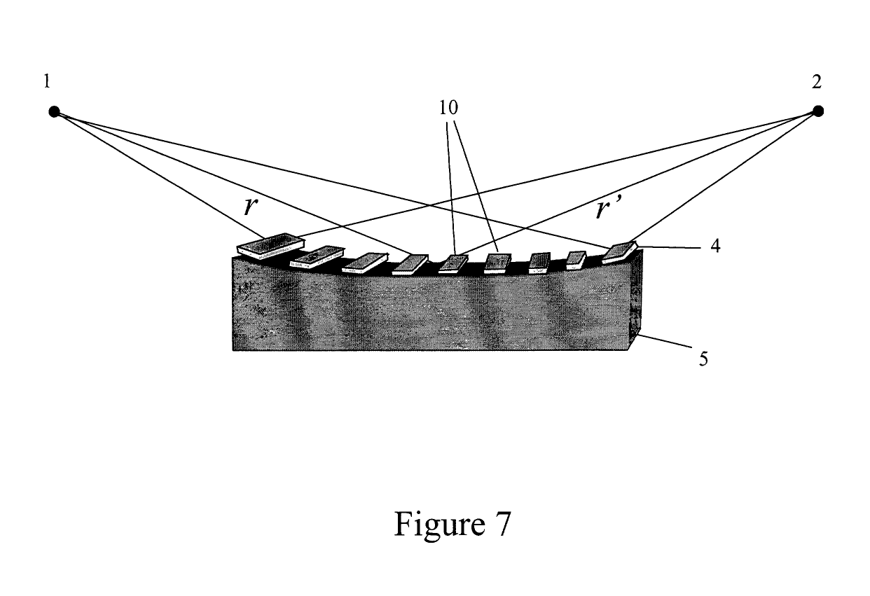

To take advantage of this effect one can adapt embodiment #1 by breaking the lengthl, of crystal 4 into shorter sections 10 as shown in FIG. 7. The sections 10 should be spaced so that the light illuminates the edge of the crystal 4 but no more.

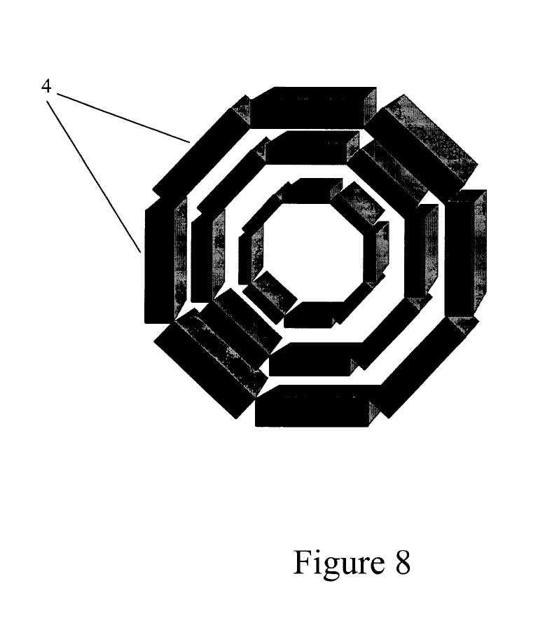

In the embodiment shown in FIG. 4, we use a single set of crystals 4 set about a central axis. This requires the crystals 4 to be made long in order to cover a large range of angles. Similarly this limits one to a single graze angle. In contrast, the embodiment shown in FIG. 8 nests rings of crystals 4. This allows for each ring to be optimized in order and wavelength for the angle off the source-focus axis. Because each crystal 4 is shorter, the quality of the focus at the focal point 2 rises. If each crystal 4 is made sufficiently short, then the efficiency enhancement of this embodiment will happen naturally, making a high efficiency, high focal quality collimator.

The ability to focus radiation precisely on a target will allow destruction of a pathologic lesion without damage to surrounding vasculature or lymphatic channels or lymph nodes. This is not now possible with conventional radiation treatments, surgery or chemotherapy. Precise destruction of a tumor as in the present invention permits the use of techniques to enhance immune response against a tumor and destruction of its blood supply, so-called anti-angiogenesis treatment, without injury to the normal structures of the body needed to achieve this.

Crystals, such as silicon, are grown and then sliced into thin wafers. The cuts are made in parallel planes, which are approximately perpendicular to the long axis of the large crystal. However, these cuts are not necessarily parallel to the molecular lattice structure within the crystal. Furthermore, the strips for a concentrator are formed by a second series of cuts made perpendicular to the plane of the wafer. As a result, the individual strips cut from such wafers can have three possible asymmetric orientations of the molecular, crystal lattice with respect to the surface. Though x-rays may appear to strike the crystal's surface at the desired angle, such asymmetry will create misalignment of the crystal lattice below the surface where the diffraction actually takes place.

A method has been devised and implemented to improve the chance of the incidence x-rays striking the lattice at the Bragg angle, and thereby improve the reflection efficiency. The large crystals are first cut as close to parallel as possible with the crystal's molecular planes. The second set of cuts to produce the strips out of the wafer are also cut in parallel with the lattice pattern. Finally, any lattice asymmetry with respect to the surface is precisely measured. Any measured irregularity between the crystal lattice, and the surface is accounted for in design of the curvature of the reflective surface of the concentrator. For example, the crystal can be cut so that its faces correspond more accurately to the crystal's molecular planes. The orientation of the crystal can also be adjusted so that incident x-rays strike the crystal lattice at the Bragg angle. In addition, the design of the curvature of the reflective surface can be used to compensate for lattice asymmetry.

These techniques optimize the frequency of rays striking the crystal at the correct Bragg angle, and therefore maximizes the efficiency of the reflections. This is critical to making a practical concentrator as the reflection efficiency drops significantly at higher kilovoltage energies.

The above disclosure sets forth a number of embodiments of the present invention. Other arrangements or embodiments, not precisely set forth, could be practiced under the teachings of the present invention and as set forth in the following claims.

We claim:

1. An apparatus for focusing x-rays on a selected region of a patient, said apparatus comprising:
an x-ray source generating x-ray radiation; and
at least one reflective element having a crystalline structure with a curved spiral shape aligned to reflect x-ray radiation from the x-ray source onto a selected region of a patient by Bragg reflection.

2. The apparatus of claim 1 wherein the curved spiral shape of the reflective element follows the equation in polar coordinates:
r=r₀e^{(θ/tan θ}^{_{B}})
wherein r₀ is the distance from the x-ray source to the surface of the reflective element for θ=0, and θ_{B} is the Bragg angle.

3. The apparatus of claim 1 wherein a plurality of reflective elements are radially aligned about a common central axis extending from the x-ray source to the selected region of a patient, and wherein each of the reflective elements focuses x-ray radiation from the x-ray source onto the selected region of a patient.

4. The apparatus of claim 1 wherein the reflective element comprises a plurality of short sections having edges, said sections spaced so that x-ray radiation from the x-ray source illuminates the edges of the sections.

5. The apparatus of claim 1 wherein the reflective element comprises silicon.

6. The apparatus of claim 1 wherein the reflective element comprises graphite.

7. An apparatus for focusing x-rays on a selected region of a patient, said apparatus comprising:
an x-ray source generating x-ray radiation; and
at least one reflective element having a crystalline structure aligned to reflect x-ray radiation from the x-ray source onto a selected region of a patient by Bragg reflection, wherein the reflective element has a curved spiral shape selected so that a constant reflection angle is maintained for x-rays diverging from the x-ray source.

8. The apparatus of claim 7 wherein the curved spiral shape of the reflective element follows the equation in polar coordinates:
r=r₀e^{(θ/tan θ}^{_{B}})
wherein r₀ is the distance from the x-ray source to the surface of the reflective element for θ=0, and θ_{B} is the Bragg angle.

9. The apparatus of claim 7 wherein a plurality of reflective elements are radially aligned about a common central axis extending from the x-ray source to the selected region of a patient, and wherein each of the reflective elements focuses x-ray radiation from the x-ray source onto the selected region of a patient.

10. The apparatus of claim 7 wherein the reflective element comprises a plurality of short sections having edges, said sections spaced so that x-ray radiation from the x-ray source illuminates the edges of the sections.

11. The apparatus of claim 7 wherein the reflective element comprises silicon.

12. The apparatus of claim 7 wherein the reflective element comprises graphite.
